(19) United States
(12) Patent Application Publication
(10) Pub. No.: US 2023/0403121 A1
(43) Pub. Date: Dec. 14, 2023

(54) METHOD AND SYSTEM FOR REFERENCE SIGNALING DESIGN AND CONFIGURATION

(71) Applicant: ZTE CORPORATION, Shenzhen (CN)

(72) Inventors: Shujuan ZHANG, Shenzhen (CN); Bo GAO, Shenzhen (CN); Ke YAO, Shenzhen (CN); Zhen HE, Shenzhen (CN); Chuangxin JIANG, Shenzhen (CN); Yang ZHANG, Shenzhen (CN); Jing LIU, Shenzhen (CN)

(73) Assignee: ZTE CORPORATION, Shenzhen (CN)

(21) Appl. No.: 18/345,842

(22) Filed: Jun. 30, 2023

Related U.S. Application Data
(63) Continuation of application No. PCT/CN2021/084992, filed on Apr. 1, 2021.

(51) Int. Cl. H04L 5/00

(52) U.S. Cl. CPC H04L 5/0053; H04L 5/0094

(57) ABSTRACT

Implementations include a wireless communication method of receiving, by a wireless communication device, a first downlink signaling indicating a Radio Network Temporary Identifier (RNTI) associated with an element. Example implementations also include a wireless communication method performed by a wireless communication device and including transmitting a message in a MAC CE or UCI, where the message includes at least one of: a UE—Context or information of a connection. Example implementations also include a wireless communication method performed by a wireless communication device and including receiving a message through at least one of a MAC CE or Downlink Control Information (DCI), where the message carries at least one of a C-RNTI, information associated with a PCI, or information of a connection.

### CROSS-REFERENCE TO RELATED APPLICATION

This application claims the benefit of priority under 35 U.S.C. § 120 as a continuation of PCT Patent Application No. PCT/CN2021/084992, filed on Apr. 1, 2021, the disclosure of which is incorporated herein by reference in its entirety.

### TECHNICAL FIELD

The present implementations relate generally to wireless communications, and more particularly to reference signaling design and configuration.

### BACKGROUND

In conventional handover/mobility of inter-cell, latency and success rate are issues, and leads to poor connectivity for mobile devices at an intersection of multiple cells.

### SUMMARY

It is advantageous to improve the latency and success rate of handover/mobility of inter-cell. Thus, a technological solution for reference signaling design and configuration is desired.

Example implementations include a wireless communication method, including receiving, by a wireless communication device, a first downlink signaling indicating a Radio Network Temporary Identifier (RNTI) associated with an element.

Example implementations also include a wireless communication method performed by a wireless communication device and including transmitting a message in a MAC CE or UCI, where the message includes at least one of a UE—Context or information of a connection.

Example implementations also include a wireless communication performed by a wireless communication device and including receiving a message through at least one of a MAC CE or Downlink Control Information (DCI), where the message carries at least one of: a C-RNTI, information associated with a PCI, or information of a connection.

Example implementations also include a wireless communication method including transmitting, by a wireless communication node, a first downlink signaling indicating a Radio Network Temporary Identifier (RNTI) associated with an element.

Example implementations also include a wireless communication method including receiving, by a wireless communication node, a message in a MAC CE or UCI, where the message includes at least one of a UE—Context or information of a connection.

Example implementations also include a wireless communication method including transmitting, by a wireless communication node, a message through at least one of a MAC CE or Downlink Control Information (DCI), where the message carries at least one of: a C-RNTI, information associated with a PCI, or information of a connection.

### BRIEF DESCRIPTION OF THE DRAWINGS

These and other aspects and features of the present implementations will become apparent to those ordinarily skilled in the art upon review of the following description of specific implementations in conjunction with the accompanying figures, wherein:

FIG. 1 illustrates an example cellular communication network in which techniques and other aspects disclosed herein may be implemented, in accordance with an implementation of the present disclosure.

FIG. 2 illustrates block diagrams of an example base station and a user equipment device, in accordance with some implementations of the present disclosure.

FIG. 3 illustrates an example where a UE in intersection of two cells each of which communicate with the UE using beams.

FIG. 4 illustrates an example where the UE and source cell exchange mobility information using MAC-CE or Physical signaling instead of RRC signaling.

FIG. 5 illustrates an example where different RNTIs and other parameters are configured for different elements of a BWP respectively, where the element can be one of: a control resource, a TCI state pool, a resource group.

FIG. 6 illustrates an example where two PDSCH from two cells has interference if they use same C-RNTI and PCI.

FIG. 7 illustrates an example where channel of UE1 and channel of UE2 from cell2 has interference or scheduling limitation if PDSCH1 and PDSCH 2 use same C-RNTI.

FIG. 8 illustrates an example where different RNTIs and other parameters are configured for different BWP of a serving cell respectively.

FIG. 9 illustrates an example where different RNTIs and other parameters are configured for different serving cells.

FIG. 10 illustrates an example where the UE determines a corresponding relationship between TCI states and information elements according to received signaling.

FIG. 11 illustrates an example where the UE determines a first corresponding relationship between PUCCH resource groups and information elements according to received signaling.

FIG. 12 illustrates an example where the UE determines a first corresponding relationship between PUCCH resource groups and information elements, and a second corresponding relationship between TCI states and information elements according to received signaling.

FIG. 13 illustrates an example where two PDSCHs from two cells has no interference if they use different C-RNTIs and PCIs, and there no interference or scheduling limitation between UE1 and UE2.

FIG. 14 illustrates an example where UE reports UE context and information of a connection using MACC-CE instead of using RRC.

FIG. 15 illustrates an example where UE determine a C-RNTI from multiple C-RNTs and carry the selected C-RNTI in a msg3/msg A.

FIG. 16 illustrates an example where UE determine a C-RNTI from multiple C-RNTs in a msg 3/msg A according to a transmitted preamble.

FIG. 17 illustrates a first example method of reference signaling design and configuration, in accordance with present implementations.

FIG. 18 illustrates a second example method of reference signaling design and configuration, in accordance with present implementations.

FIG. 19 illustrates a third example method of reference signaling design and configuration, in accordance with present implementations.

FIG. 20 illustrates a fourth example method of reference signaling design and configuration, in accordance with present implementations.

FIG. 21 illustrates a fifth example method of reference signaling design and configuration, in accordance with present implementations.

### DETAILED DESCRIPTION

The present implementations will now be described in detail with reference to the drawings, which are provided as illustrative examples of the implementations so as to enable those skilled in the art to practice the implementations and alternatives apparent to those skilled in the art. Notably, the figures and examples below are not meant to limit the scope of the present implementations to a single implementation, but other implementations are possible by way of interchange of some or all of the described or illustrated elements. Moreover, where certain elements of the present implementations can be partially or fully implemented using known components, only those portions of such known components that are necessary for an understanding of the present implementations will be described, and detailed descriptions of other portions of such known components will be omitted so as not to obscure the present implementations. Implementations described as being implemented in software should not be limited thereto, but can include implementations implemented in hardware, or combinations of software and hardware, and vice-versa, as will be apparent to those skilled in the art, unless otherwise specified herein. In the present specification, an implementation showing a singular component should not be considered limiting; rather, the present disclosure is intended to encompass other implementations including a plurality of the same component, and vice-versa, unless explicitly stated otherwise herein. Moreover, applicants do not intend for any term in the specification or claims to be ascribed an uncommon or special meaning unless explicitly set forth as such. Further, the present implementations encompass present and future known equivalents to the known components referred to herein by way of illustration.

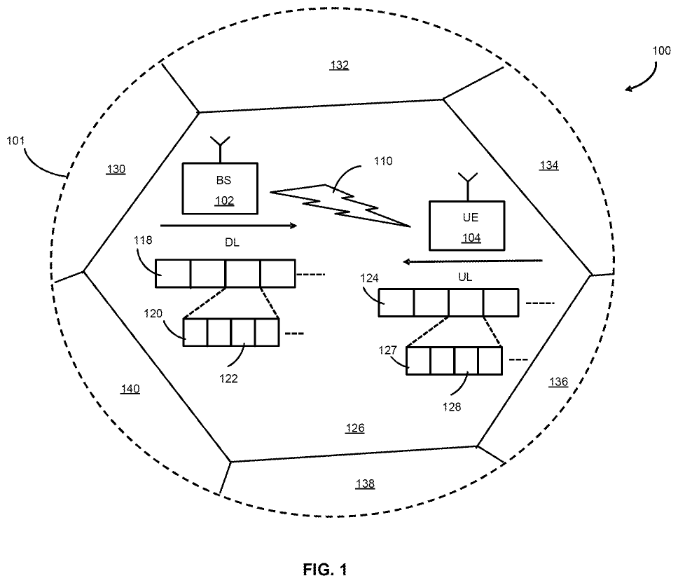

FIG. 1 illustrates an example wireless communication network, and/or system, 100 in which techniques disclosed herein may be implemented, in accordance with an implementation of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”) and a user equipment device 104 (hereinafter “UE 104”) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various implementations of the present solution.

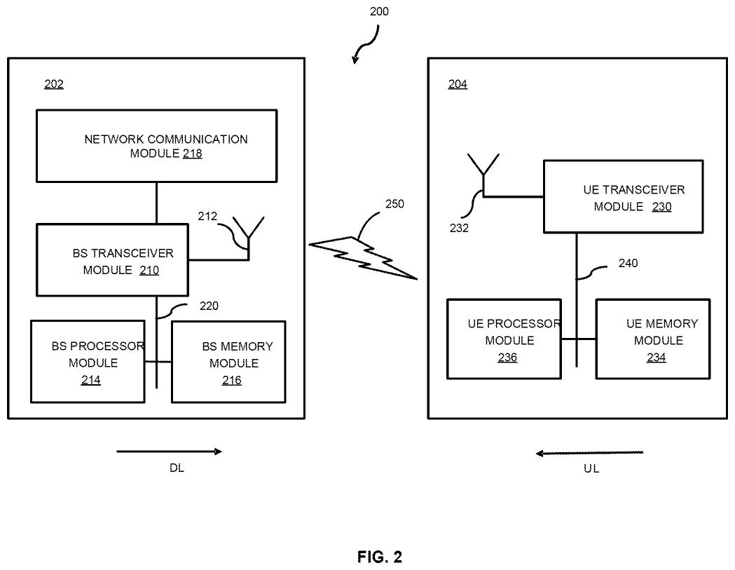

FIG. 2 illustrates a block diagram of an example wireless communication system 200 for transmitting and receiving wireless communication signals, e.g., OFDM/OFDMA signals, in accordance with some implementations of the present solution. The system 200 may include components and elements configured to support known or conventional operating features that need not be described in detail herein. In one illustrative implementation, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the implementations disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure.

In accordance with some implementations, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some implementations, the BS transceiver 210 may be referred to herein as a “downlink” transceiver 210 that includes a RF transmitter and a RF receiver each comprising circuitry that is coupled to the antenna 212. A downlink duplex switch may alternatively couple the downlink transmitter or receiver to the downlink antenna 212 in time duplex fashion. The operations of the two transceiver modules 210 and 230 can be coordinated in time such that the uplink receiver circuitry is coupled to the uplink antenna 232 for reception of transmissions over the wireless transmission link 250 at the same time that the downlink transmitter is coupled to the downlink antenna 212. In some implementations, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative implementations, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various implementations, the BS 202 may be an evolved node B (eNB), a serving eNB, a target eNB, a femto station, or a pico station, for example. In some implementations, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the implementations disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some implementations, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

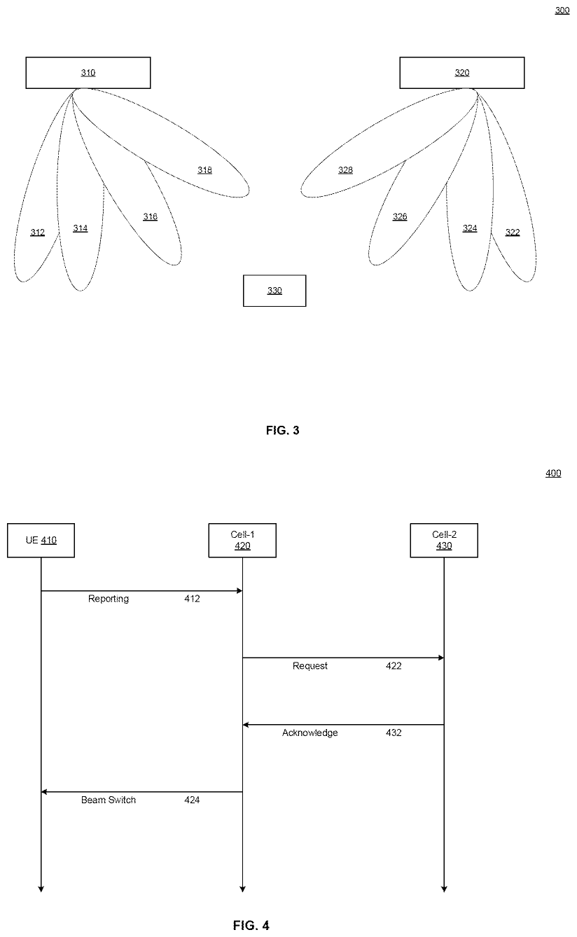

FIG. 3 illustrates an example where a UE in intersection of two cells each of which communicate with the UE using beams. As illustrated by way of example in FIG. 3, an example system 300 includes a first cell 310, a second cell 320, and a UE 330. In some implementations, the first cell 310 is associated with beams 312, 314, 316 and 318. In some implementations, the second cell 320 is associated with beams 322, 324, 326 and 328.

As shown by way of example in FIG. 3, fast beam switching between beams associated with a same cell can involve only MAC-CE/DCI signaling. Thus, in some implementations, beam switching between beams in beam set 1 including 312, 314, 316 and 318 or in beam set 2 including 322, 324, 326 and 328 is fast. But the beam switch between beams associated with different cells are very low as it introduce higher layer signaling. As one example, beam switching speed between beams comprising one from beams 312, 314, 316 and 318 and another from beams 322, 324, 326 and 328 is lower. In some implementations, this beam switching can reduce the latency of beam switching between beams associated with different cells. Following enhancement described in following example can not only reduce the latency but also improve the success of handover, and supports two cells serving the UE simultaneously with low UE complexity.

FIG. 4 illustrates an example where the UE and source cell exchange mobility information using MAC-CE or Physical signaling instead of RRC signaling. As illustrated by way of example in FIG. 4, an example communication 400 includes a UE 410, a first cell 420, and a second cell 430. In some implementations, the UE 410 is associated with a reporting communication 412 using UCI/MAC-CE. In some implementations, the first cell 420 is associated with a request communication 422 and a beam switch communication 424 between beams of different cells using DCI/MAC-CE. In some implementations, the second cell 430 is associated with an acknowledge communication 432.

As shown by way of example in FIG. 4, the UE first reports beam selection and beam quality for more than one cells using uplink control information (UCI) or MAC-CE instead of using RRC signaling. The UE can timely inform the first cell of the beam of the UE, especially when the UE selects beams from a cell other than the first cell, such as the second cell. Then, the first cell can use MAC-CE/DCI to inform the UE to switch beams associated with different cells using MAC-CE/DCI. The first cell may be a source cell and the second cell may be a target cell or a neighboring cell. The two cells can be associated with a different physical cell index (PCI) for each.

In this example, the UE receives MAC-CE/DCI which includes one or more of a PCI, RNTI, at least one security algorithm identifier, and SIB information. The UE can use this information after receiving the MAC-CE/DCI. The SIB can be an SIB for target cell. The SIB can include a set of dedicated RACH resources, the association between RACH resources and SSB(s), the association between RACH resources and UE-specific CSI-RS configuration(s), common RACH resources, and system information of the target cell. As shown by way of example in FIG. 4, the source cell can inform UE of information of target cell using MAC-CE/DCI instead of using RRC signaling.

Further when the MAC-CE/DCI includes RNTI, or RNTI and PCI, the MAC-CE/DCI can also include the index of element for which the indicated RNTI, or RNTI and PCI is applied, wherein the element includes one of: control resource, BWP, serving cell, a Transmission Configuration Indicator (TCI) state, a spatial relation indicator, a TCI state pool, or a spatial relation indicator pool, resource, resource set, wherein the resource includes one of reference signal resource such as SRS resource, CSI-RS resource, RLM-RS resource, channel resource such as PUCCH resource.

FIG. 5 illustrates an example where different RNTIs and other parameters are configured for different elements of a BWP respectively, where the element can be one of: a control resource, a TCI state pool, a resource group. As illustrated by way of example in FIG. 5, an example system 500 includes a BWP 510, a first cell 520 of PCI1 and RNTI1, a second cell 530 of PCI2 and RNTI2, and a UE 540. In some implementations, the first cell 520 is associated with PUCCH1/PUSCH1 522, and PDCCH1/PDSCH1 524. In some implementations, the second cell 530 is associated with PUCCH2/PUSCH2 532, and PDCCH2/PDSCH2 534.

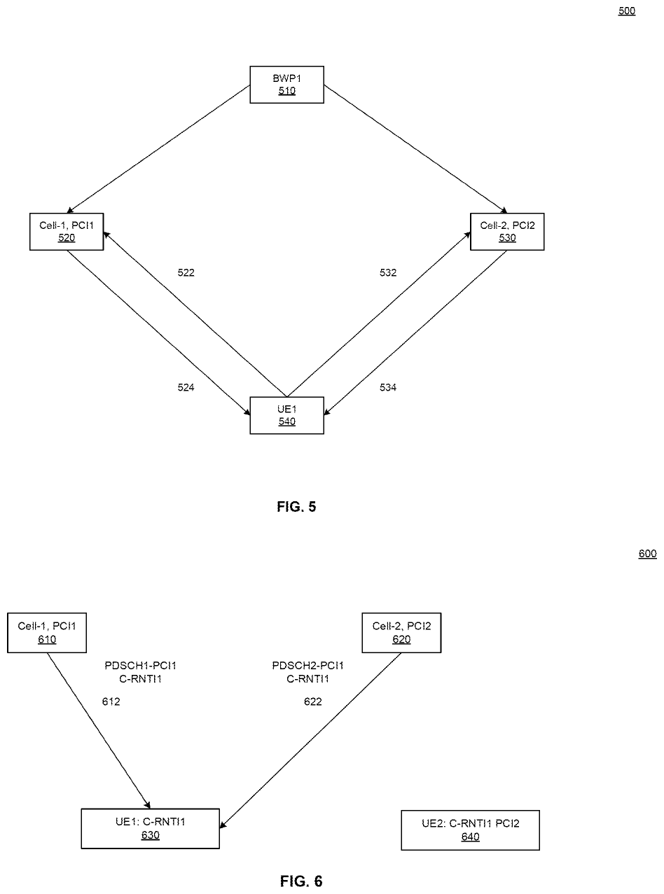

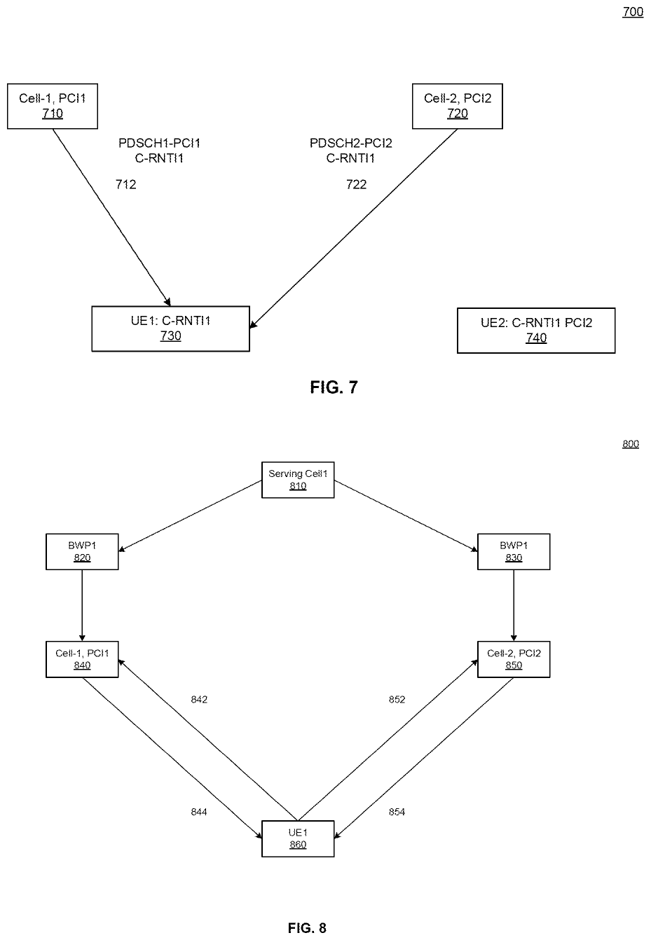

As shown by way of example in FIG. 5, the UE receives downlink channel or signal from the two cells in a same downlink BWP and the UE transmits uplink channel or signal to the two cells in a same uplink BWP, i.e the two cells communicate with the UE in a same BWP. At least one parameter of the channels or signals from or to the different cells can be different, to minimize or eliminate interference with the cell attempting to identify different UEs as shown in FIGS. 6 and 7. In these two example figures, the cell 1 is serving cell/source cell of UE1. Cell 1 has assigned UE 1 with C-RNTI 1, the best neighboring cell/target cell of UE1 is cell2, but the cell 2 has assigned UE2 in its area with C-RNTI1 same as UE1. In FIG. 6, the same PCI and RNTI are used for PDSCH1 from the cell 1 and PDSCH2 from cell2. Thus, PDSCH1 and PDSCH 2 do not overlap and the cell2 does not schedule UE1 and UE2 without limitations, because they are associated with same C-RNTI. In FIG. 7, different PCIs and same RNTI are used for PDSCH1 and for PDSCH2 Thus, PDSCH1 and PDSCH 2 can overlap, but the cell2 does not schedule UE1 and UE2 freely, because they are associated with same C-RNTI.

As shown by way of example in FIG. 5, channels or signals of one BWP can be divided into two groups, each of which correspond to different cells with different parameters, such as PCI and RNTI. For example, the UE receives signaling which includes the parameter associated a control channel resource which can be one of CORESET, search space set, CORESET pool, or a pool of a search space set. The PDCCH in a control channel resource can be transmitted using a parameter corresponding to the control channel resource. The channel or signals scheduled by a PDCCH in a control channel resource can be transmitted or received using a parameter corresponding to the a control channel resource. In some implementations, different control channel resources in one BWP can correspond to different parameters. The channel or signals without PDCCH can be configured with a corresponding control channel resource. Then, the channel or signals without PDCCH can be transmitted or received using parameter corresponding to the control channel resource. The channel or signals without PDCCH can include at least one of periodic or semi-persistent signals, and a semi-persistent channel.

In some implementations, the UE receives signaling which includes mapping relationship between PCI and parameter such as RNTI. In some implementations, the UE gets the parameter of the channels or signals from or to the different cells according to PCI associated the channels or signals.

In some implementations, the parameter includes Radio Network Temporary Identifier (RNTI) and/or PCI. The RNTI includes at least one of cell-RNTI (C-RNTI), modulation and coding scheme (MCS)-C-RNTI, CS-RNTI, semi-persistent (SP) channel state information (CSI) SP-CSI-RNTI, or other RNTI to identify the UE. The parameter can also include one or more following parameters including the parameter used to generate scrambling sequence for a channel (such as n ID), rate mating parameters, power control parameters, the parameter used to generate sequence for a signal, timing information, time advance (TA), or SSB information, wherein the power control parameter includes at least one of: a factor associated with a path loss reference signal such as alpha, target receive power p₀, closed loop index. The SSB information includes at least one of SSB time domain position, SSB power, or SSB periodicity. The UE receives signaling indicating the parameter for an element of a BWP, wherein the element includes one of: a control resource, a TCI state pool, a TCI state, a resource, a resource group, wherein the resource includes reference signal resource, or channel resource.

The gNB also can inform the UE whether the channels or signals from or to the different cells each of which corresponds a respective PCI are associated with respective parameter.

With respect to FIGS. 5-7, the PCI can be used as n_{ID} used to generate scrambling sequence of a channel. For example, the scrambling sequence of PDCCH is a pseudo-random sequence generator which is initialized with cᵢₙᵢₜ=(n_{RNTI·}2¹⁶+n_{ID})mod2³¹, where RNTI is the C-RNTI for a UE-specific search space set and is 0 for other cases. n_{ID} The n_{ID} can be configured as the PCI. It is to be understood that the n_{ID} can be configured with other values. For example, the gNB configures PCI, RNTI, n_{ID} for an element including one of: a control resource, a BWP, a serving cell, a BWP set, a serving cell set.

FIG. 6 illustrates an example where two PDSCH from two cells has interference if they use same C-RNTI and PCI. As illustrated by way of example in FIG. 6, an example system 600 includes a first cell 610 of PCI1, a second cell 620 of PCI2, a first UE 630 of C-RNTI1, and a second UE 640 of C-RNTI1 and PCI2. In some implementations, the first cell 610 is associated with PDSCH1-PCI1 C-RNTI1 612. In some implementations, the second cell 620 is associated with PDSCH2-PCI1 C-RNTI1 622.

FIG. 7 illustrates an example where channel of UE1 and channel of UE2 from cell2 has interference or scheduling limitation if PDSCH1 and PDSCH 2 use same C-RNTI. As illustrated by way of example in FIG. 7, an example system 700 includes a first cell 710 of PCI1, a second cell 720 of PCI2, a first UE 730 of C-RNTI1, and a second UE 740 of C-RNTI1 and PCI2. In some implementations, the first cell 710 is associated with PDSCH1-PCI1 C-RNTI1 712. In some implementations, the second cell 720 is associated with PDSCH2-PCI2 C-RNTI1 722.

FIG. 8 illustrates an example where different RNTIs and other parameters are configured for different BWP of a serving cell respectively. As illustrated by way of example in FIG. 8, an example system 800 includes a serving cell 810, a first BWP 820, a second BWP 830, a first cell 840 of PCI1 and RNTI1, a second cell 850 of PCI2 and RNTI2, and a UE 860. In some implementations, the first cell 840 is associated with PUCCH1/PUSCH1 842, and PDCCH1/PDSCH1 844. In some implementations, the second cell 850 is associated with PUCCH2/PUSCH2 532, and PDCCH2/PDSCH2 534.

Channels or signals from or to the different cells each of which corresponds a respective PCI are in two BWPs of a serving cell are shown by way of example in FIG. 8. The two BWPs can be configured with different parameters. Then the channels or signals from or to the different cells can be transmitted using different parameters. The different BWPs of a serving cell can be associated with different RNTI and at least one of: PCI, SSB information, time advance (TA). For example, the BWPs of a serving cell are divided to more than one groups each of which is associated with a RNTI and and at least one of: PCI, SSB information, time advance (TA). More than one BWPs can be activated for a UE simultaneously for a serving cell. Optionally, the more than one activated BWPs correspond to different RNTI/PCI. Some configuration of the more than one activated BWPs can satisfy a predetermined condition. The configuration can include one or more of a cyclic prefix (CP), subcarrier spacing, and a frequency parameter. Then the channels or signals from or to the different cells each of which corresponds a respective PCI corresponds to same MAC entity.

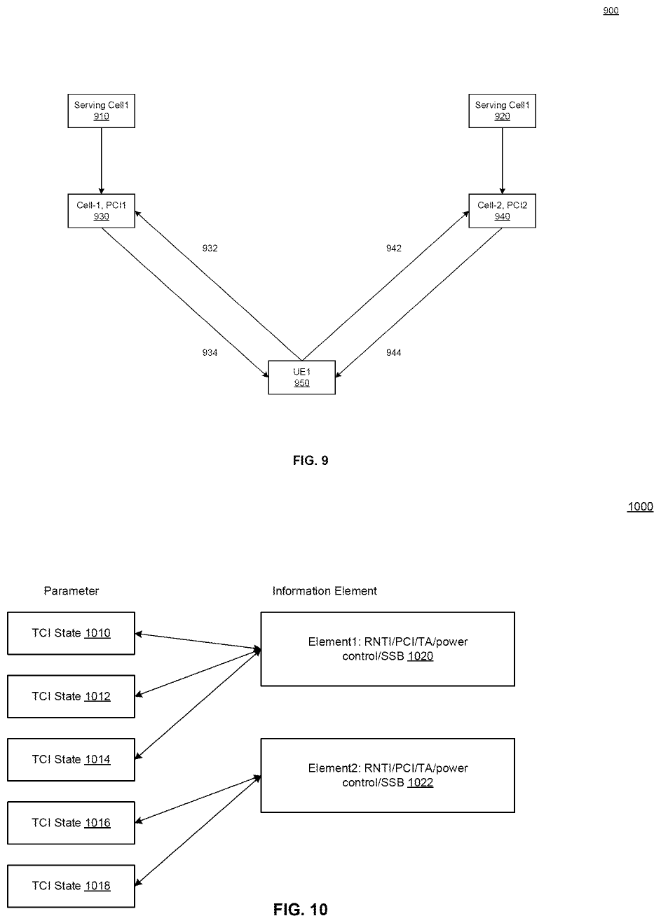

FIG. 9 illustrates an example where different RNTIs and other parameters are configured for different serving cells. As illustrated by way of example in FIG. 9, an example system 900 includes a first serving cell 910, a second serving cell 920, a first cell 930 of PCI1, a second cell 940 of PCI2, and a UE 950. In some implementations, the first cell 930 is associated with PUCCH1/PUSCH1 932, and PDCCH1/PDSCH1 934. In some implementations, the second cell 940 is associated with PUCCH2/PUSCH2 942, and PDCCH2/PDSCH2 944.

Channels or signals from or to the different cells, each of which corresponds a respective PCI, are in two serving cells of a serving cell group, as shown by way of example in FIG. 9. The serving cells of a serving cell group can be associated with different RNTI and at least one of: PCI, SSB information, time advance (TA). For example, the serving cells of a serving cell group are divided to more than one sets each of which is associated with a RNTI and/or at least one of: PCI, SSB information, time advance (TA). The set can be a set in a TAG (TA group) Then, the channels or signals from or to the different cells each of which corresponds a respective PCI can be mapped to different HARQ-ACK entities and be mapped to a same MAC entity. Different serving cell groups can correspond to different at least one of MAC entities, Serving Cells, C-RNTI, radio bearers, logical channels, upper and lower layer entities (including but not limited to RRC, RLC, PDCP layer, PHY layer), Logical channel groups, and HARQ entities. The serving cell group can be one of a master cell group (MCG), a secondary cell group (SCG), and a CG of SCell with PUCH. In some implementations, the serving cells in a serving cell group is divided to multiple serving cell sets each of which is configured with a RNTI/PCI.

In some implementations, the gNB configures RNTI/PCI for an element of a frequency unit which includes one of a serving cell group, a serving cell, and a BWP, where the element can be one of: a control resource when the frequency unit is a BWPe, a BWP when the frequency unit is a serving cell group or a serving cell, a BWP set of a serving cell when the frequency unit is a serving cell group or a serving cell, a serving cell when the frequency unit is a serving cell group, a serving cell set when the frequency unit is a serving cell group, a PCI, and a PCI set. The channel or signal associated with element can be received or transmitted according to RNTI/PCI associated with the element. For example, the scrambling sequence of the channel is generated according to the RNTI associated with elements of the channel. The scrambling sequence of PDCCH can include a scrambling sequence with length same as bit sequence after channel code and used to scramble the bit sequence after channel code. The scrambling sequence of PDCCH can also include scrambling sequence with 16 bit and used to scramble cyclic redundancy check (CRC) bit sequence before channel code.

In view of FIG. 5, 8 or 9, the UE can receive PDSCH from different cells as shown in FIG. 10. The PDSCH1 and PDSCH2 can overlap in time and/or frequency resource. The cell2 can schedule the UE1 and UE2 without any limitation because they can be identified by cell 2 using different RNTI.

FIG. 10 illustrates an example where the UE determines a corresponding relationship between TCI states and information elements according to received signaling. As illustrated by way of example in FIG. 10, an example system 1000 includes parameters 1010, 1012, 1014, 1016 and 1018, and information elements 1020 and 1022.

In some implementations, the UE receives signaling indicating a corresponding relationship between a parameter and an information element. For example, the parameter can be one of a transmission configuration indication (TCI) state, a Spatial relationship indicator, TCI state pool, or a Spatial relation ship indicator pool.

As one example, the UE first determines the parameter of a channel or a signal. Then the UE determines the information element of the channel or signal includes the information element corresponding to the parameter as shown by way of example in FIG. 10. For example, the UE determines TCI state of PDSCH is TCI state1, then the UE determines the information element of the PDSCH is element 1. The UE can determine that the information of the PDSCH is the information of the element 1. For example, the information element includes at least one of the following information: RNTI, PCI, TA, control power information, SSB information, rating mating information, or n_{ID}, wherein n_{ID} is scrambling ID used to generate scrambling sequence of a channel.

FIG. 11 illustrates an example where the UE determines a first corresponding relationship between PUCCH resource groups and information elements according to received signaling. As illustrated by way of example in FIG. 11, an example system 1100 includes a first PUCCH resource group 1110, a second PUCCH resource group 1112, a first element 1120, and a second element 1122.

In some implementations, the UE receives signaling indicating a first corresponding relationship between a resource group and an information element. The UE can determine information included in the information element for the resource of a resource group according to the information element corresponding to the resource group as shown by way of example in FIG. 11. The resource group includes a channel resource group such as a PUCCH resource group, or reference signal resource group such as an SRS resource group, CSI-RS resource group, or CSI-RS/SSB resource group for radio link monitoring (RLM). Different information elements are associated with different RLM-RS set/RLM-RS resource. If the RLM-RS set doesn't be configured, the UE gets the RLM-RS according to QCL-RS of CORESET associated with a predefined information elements. The UE determines whether Radio link out for each RLM-RS sets of a serving cell, or The UE determines whether Radio link out according to multiple RLM-RS sets of a serving cell, each of the RLM-RS set is associated with the information element respectively.

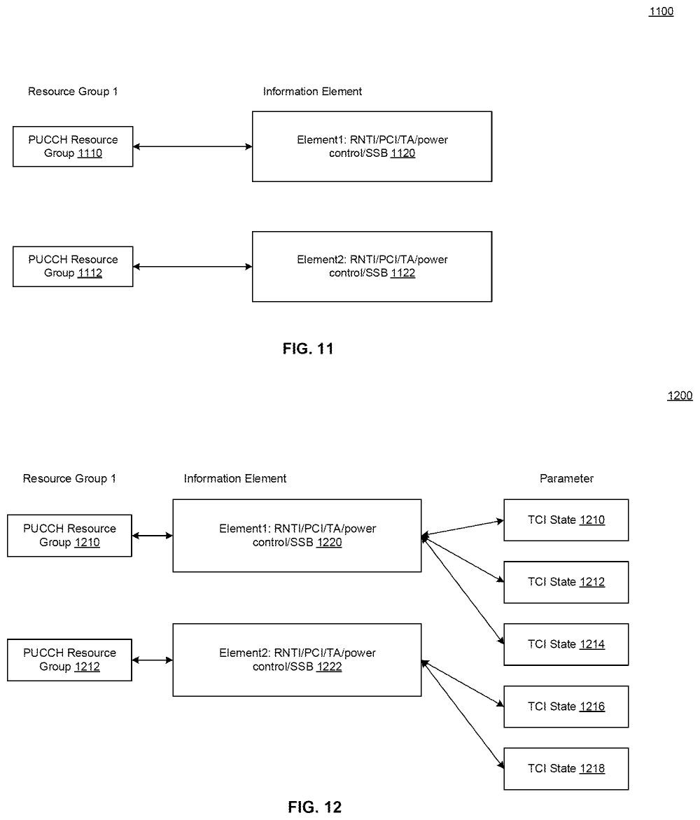

FIG. 12 illustrates an example where the UE determines a first corresponding relationship between PUCCH resource groups and information elements, and a second corresponding relationship between TCI states and information elements according to received signaling. As illustrated by way of example in FIG. 12, an example system 1200 includes a first PUCCH resource group 1110, a second PUCCH resource group 1112, a first element 1120, a second element 1122, and parameters 1210, 1212, 1214, 1216 and 1218.

Further, the UE can receive signaling with a second corresponding relationship between parameter and the information element as shown by way of example in FIG. 12. When the UE receives a MAC-CE/DCI carrying the parameter, the UE can determine a resource group for which the parameter is applied according to the first and the second corresponding relationship. For example, when the MAC-CE/DCI carries TCI state1, then the TCI state 1 can be applied for PUCCH resource group 1. The TCI state 1 in the MAC-CE/DCI will not be applied for PUCCH resource group 2 which does not have a corresponding relationship with TCI state 1.

As illustrated by way of example in FIGS. 10-12, the SSB information in the information element can include at least one of SSB time domain information, SSB periodic, or SSB power. The control information includes at least of: a factor associated with a path loss reference signal such as alpha, target receive power p₀, closed loop index.

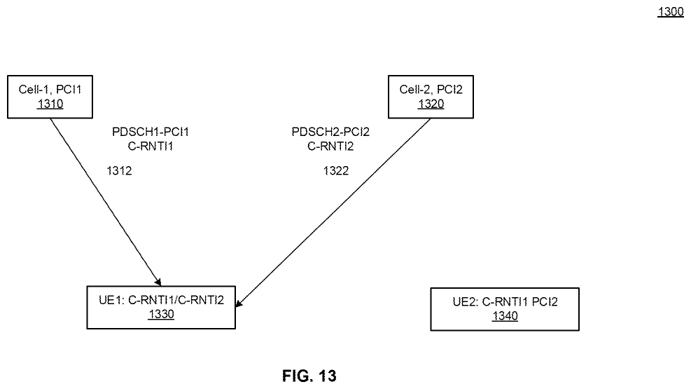

FIG. 13 illustrates an example where two PDSCHs from two cells has no interference if they use different C-RNTIs and PCIs, and there no interference or scheduling limitation between UE1 and UE2. As illustrated by way of example in FIG. 13, an example system 1300 includes a first cell 1310 of PCI1, a second cell 1320 of PCI2, a first UE 1330 of C-RNTI1/C-RNTI2, and a second UE 1340 of C-RNTI1 and PCI2. In some implementations, the first cell 1310 is associated with PDSCH1-PCI1 C-RNTI1 1312. In some implementations, the second cell 1320 is associated with PDSCH2-PCI2 C-RNTI1 1322.

In accordance with at least FIGS. 3, 6 and 7, the UE can receive PDSCH from different cells as shown by way of example in FIG. 13. The PDSCH1 and PDSCH2 can overlap in time and/or frequency resource. The cell2 can schedules the UE1 and UE2 without limits because they can be identified by cells using different RNTI.

As shown by way of example in FIG. 13, where UE1 is assigned with more than one RNTI, then the number of RNTIs may be needed to extended. In some implementations, the range of RNTI is 0˜2¹⁶−1. Thus, in some implementations, RNTI is a 16 bits number. When a UE needs more than one RNTI of the same type such as one of C-RNTI, MCS-C-RNTI, CS-RNTI, SP-CSI-RNTI, or other RNTI to identify the UE, the number of bits used for RNTI may be extended. For example, the number of bits used of RNTI may be extended from 16 bits to 20 bits/24 bits. Then the formula for generating scrambling sequence can be modified accordingly. For example, the scrambling sequence of PDCCH can be a pseudo-random sequence generator which is initialized with cᵢₙᵢₜ=(n_{RNTI}·2^{x}+n_{ID})mod 2³¹, where RNTI is the C-RNTI for UE-Specific search space set and is 0 for other case. If the number of bits used for RNTI is more than 16, the above formula is modifiable as cᵢₙᵢₜ=(n_{RNTI}2^{x}+n_{ID}) mod 2³¹ where x ∈{10,11,12,13,14,15,16} and x can be configured by a predefined value.

The scrambling sequence of PDSCH can be a pseudo-random sequence generator which is initialized with cᵢₙᵢₜ=(n_{RNTI}2^{y+1}+q2^{y}+n_{ID}) mod 2³¹ cᵢₙᵢₜ=n_{RNTI}2^{y+1}+q2^{y}+q2^{y}+n_{ID}, where y ∈{10,11,12,13,14,15,16} and y can be configured by a predefined value.

The UE can report its RNTI/PCI using MAC-CE and/or UCI to gNB. For example the UE reports its RNTI/PCI associated with a source gNB to a target gNB. The MAC-CE/UCI can be transmitted during PRACH processes. The MAC-CE/UCI also be transmitted in PUSCH/PUCCH, where the PUSCH/PUCCH is for the target gNB. For example, the spatial of PUSCH/PUCCH can be received based on SSB/CSI-RS from the target gNB. The target gNB can also be a neighboring gNB, or can be a TRP.

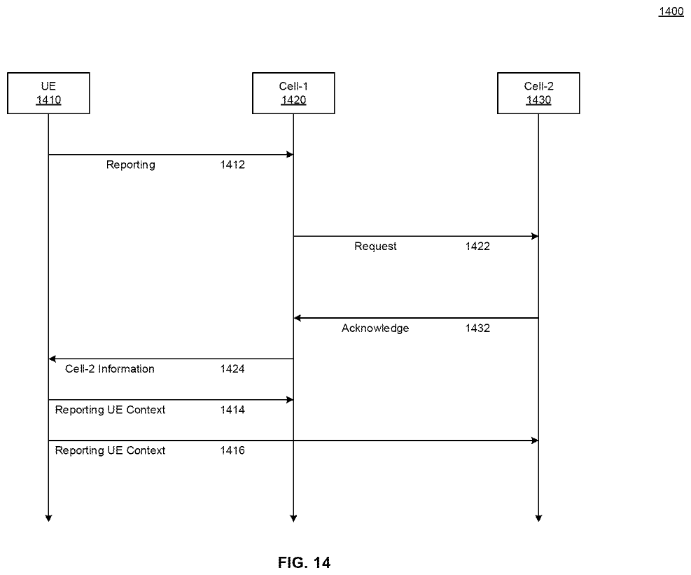

FIG. 14 illustrates an example where UE reports UE context and information of a connection using MACC-CE instead of using RRC. As illustrated by way of example in FIG. 14, an example communication 1400 includes a UE 1410, a first cell 1420, and a second cell 1430. In some implementations, the UE 1410 is associated with a first reporting communication 1412 using UCI/MAC-CE, a second reporting communication 1414 of UE context using UCI/MAC-CE, and a third reporting communication 1416 of UE context using UCI/MAC-CE. In some implementations, the first cell 1420 is associated with a request communication 1422 and an information communication 1424 of the second cell 1430. In some implementations, the second cell 1430 is associated with an acknowledge communication 1432.

The UE can report UE context using MAC-CE and/or UCI to gNB. The UE context can include one or more of the following information: the PCI of the source gNB, the C-RNTI of the UE in the source gNB, RRM-configuration including UE inactive time, basic AS-configuration including antenna Info and DL Carrier Frequency, the current QoS flow to DRB mapping rules applied to the UE, the SIB1 from source gNB, the UE capabilities for different RATs, PDU session related information, and can include the UE reported measurement information including beam-related information if available, EARLY STATUS TRANSFER message. The DL COUNT value conveyed in the EARLY STATUS TRANSFER message indicates PDCP SN and HFN of the first PDCP SDU that the source gNB forwards to the target gNB. The UE can report UE context using MAC-CE and/or UCI to source cell or target cell as shown by way of example in FIG. 14.

In some implementations, handover involves transmitting information using RRC signaling, such as RRC resume request, RRC setup, RRC setup complete, RRC release, RRC reestablishment, RRC reestablishment complement, RRC reconfigure, RRC reconfigure complement. The information included in this RRC signaling can be included MAC-CE/UCI to fast the speed of handover/mobility.

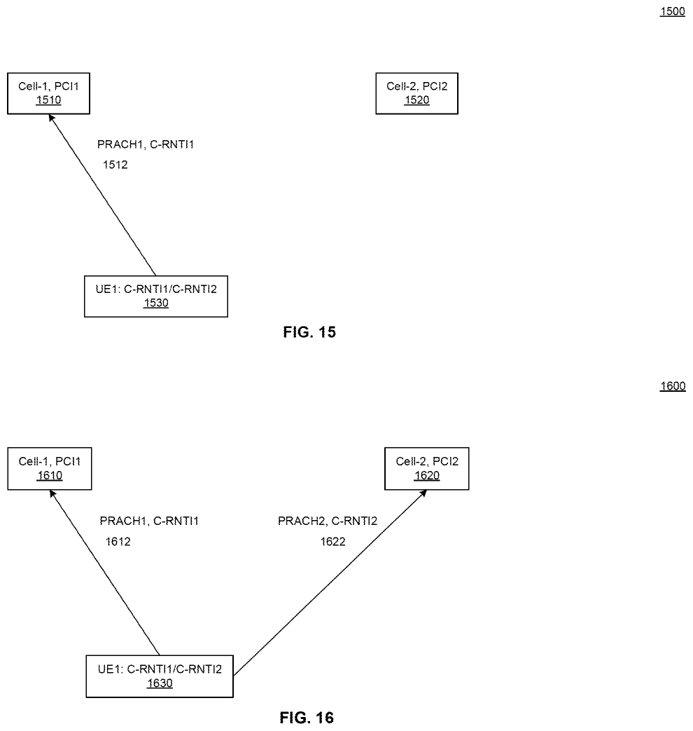

FIG. 15 illustrates an example where UE determine a C-RNTI from multiple C-RNTs and carry the selected C-RNTI in a msg3/msg A. As illustrated by way of example in FIG. 15, an example system 1500 includes a first cell 1510 of PCI1, a second cell 1520 of PCI2, and a UE 1530 of C-RNTI1/C-RNTI2. In some implementations, the first cell 1510 is associated with PRACH1 C-RNTI1 1512.

FIG. 16 illustrates an example where UE determine a C-RNTI from multiple C-RNTs in a msg 3/msg A according to a transmitted preamble. As illustrated by way of example in FIG. 16, an example system 1600 includes a first cell 1610 of PCI1, a second cell 1620 of PCI2, and a UE 1630 of C-RNTI1/C-RNTI2. In some implementations, the first cell 1610 is associated with PRACH1 C-RNTI1 1612. In some implementations, the second cell 1620 is associated with PRACH2 C-RNTI2 1622.

The UE can determine one C-RNTI satisfying a predefined condition. The UE can report the determined C-RNTI in msg3 or msg A during a PRACH process. As in the above examples, the UE in RRC_connected state can keep more than one C-RNTI for different cell. When the UE needs to send contention based PRACH, the UE can determine which one will be included in msg(message)3/msg A to be a contention resolution identifier. The UE can determine the first C-RNTI or the C-RNTI received from prior PRACH process, as shown by way of example in FIG. 15. Further, the UE can determine the C-RNTI according to the preamble transmitted by the UE in msg 1/msg A. For example, if the preamble associated with PCI1, the C-RNTI1 is included in the msg3. If the preamble is associated with PCI2, the C-RNTI2 can be included in the msg3 as shown by way of example in FIG. 16. The UE can receive the associated relationship between PCIs and C-RNTIs based on a rule or received signaling.

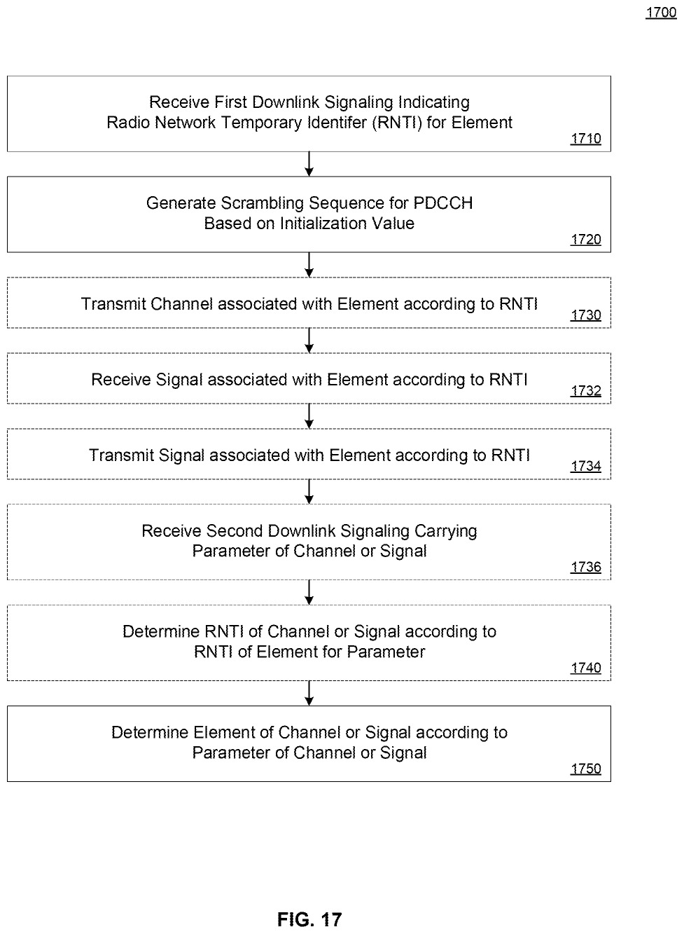

FIG. 17 illustrates a first example method of reference signaling design and configuration, in accordance with present implementations. In some implementations, at least one of the example system 100 and 200 performs method 1700 according to present implementations. In some implementations, the method 1700 begins at step 1710.

At step 1710, the example system receives first downlink signaling indicating a radio network temporary identifier (RNTI) for an element. The method 1700 then continues to step 1720. At step 1720, the example system generates a scrambling sequence for PDCCH based on an initialization value. In some implementations, the initialization value is determined by a particular equation and the initialization value is determined according the RNTI got according to step 1710, or 1710 and one of 1740, 1750. The method 1700 then continues to step 1730. In some implementation, the method 1700 ends at step 1720.

At step 1730, the example system transmits a channel associated with an element according to an RNTI. The method 1700 then continues to step 1732. At step 1732, the example system receives a signal associated with an element according to an RNTI. The method 1700 then continues to step 1734. At step 1734, the example system transmits a signal associated with an element according to an RNTI. The method 1700 then continues to step 1736. At step 1736, the example system receives second downlink signaling carrying a parameter of a channel or a signal. It is to be understood that the example system can optionally or alternatively perform at least one of steps 1730, 1732, 1734 and 1736. The method 1700 then continues to step 1740. In some implementation, the method 1700 ends at step 1730.

At step 1740, the example system determines RNTI of a channel or signal according to RNTI of an element or parameter. The method 1700 then continues to step 1750. At step 1750, the example system determines an element of a channel or signal according to a parameter of the channel or signal. In some implementations, the method 1700 ends at step 1740.

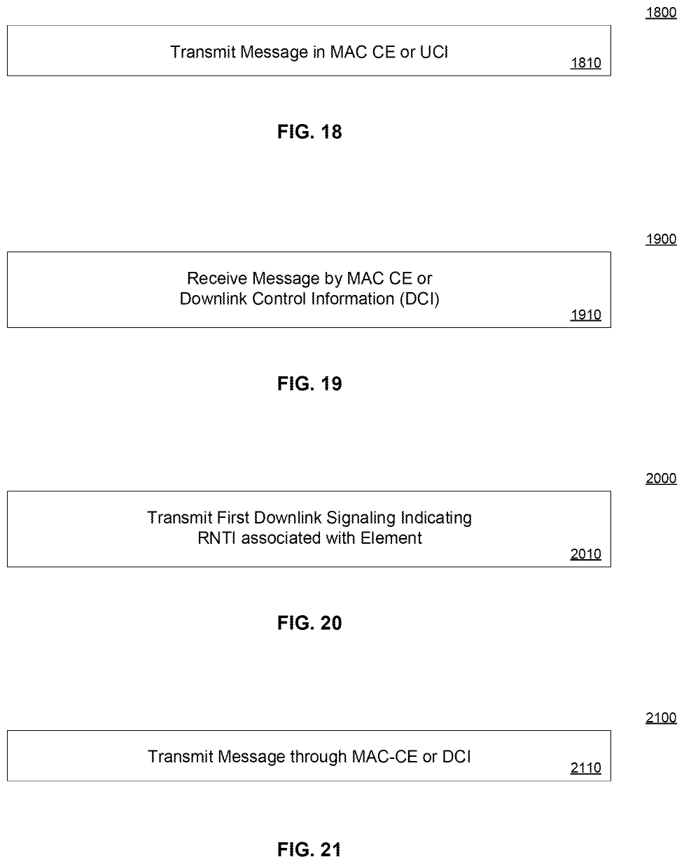

FIG. 18 illustrates a second example method of reference signaling design and configuration, in accordance with present implementations. In some implementations, at least one of the example system 100 and 200 performs method 1800 according to present implementations. In some implementations, the method 1800 begins at step 1810. At step 1810, the example system transmits a message in MAC-CE or UCI. In some implementations, the method 1800 ends at step 1810.

FIG. 19 illustrates a third example method of reference signaling design and configuration, in accordance with present implementations. In some implementations, at least one of the example system 100 and 200 performs method 1900 according to present implementations. In some implementations, the method 1900 begins at step 1910. At step 1910, the example system receives a message by MAC-CE or downlink control information (DCI). In some implementations, the method 1900 ends at step 1910.

FIG. 20 illustrates a fourth example method of reference signaling design and configuration, in accordance with present implementations. In some implementations, at least one of the example system 100 and 200 performs method 2000 according to present implementations. In some implementations, the method 2000 begins at step 2010. At step 2010, the example system transmits first downlink signaling indicating RNTI associated with an element. In some implementations, the method 2000 ends at step 2010.

FIG. 21 illustrates a fifth example method of reference signaling design and configuration, in accordance with present implementations. In some implementations, at least one of the example system 100 and 200 performs method 2100 according to present implementations. In some implementations, the method 2100 begins at step 2110. At step 2110, the example system transmits a message through MAC-CE or DCI. In some implementations, the method 2100 ends at step 2110.

The herein described subject matter sometimes illustrates different components contained within, or connected with, different other components. It is to be understood that such depicted architectures are illustrative, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It will be further understood by those within the art that if a specific number of an introduced claim recitation is intended, such an intent will be explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general, such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

Further, unless otherwise noted, the use of the words “approximate,” “about,” “around,” “substantially,” etc., mean plus or minus ten percent.

The foregoing description of illustrative implementations has been presented for purposes of illustration and of description. It is not intended to be exhaustive or limiting with respect to the precise form disclosed, and modifications and variations are possible in light of the above teachings or may be acquired from practice of the disclosed implementations. It is intended that the scope of the invention be defined by the claims appended hereto and their equivalents.

1. A wireless communication method, comprising:
receiving, by a wireless communication device from a wireless communication node, a first downlink signaling,
wherein the first downlink signaling is configured to indicate a Radio Network Temporary Identifier (RNTI) associated with an element.

2. The method of claim 1, wherein a frequency unit includes up to a predefined number of elements, each of the predefined number of elements associated with a respective RNTI.

3. The method of claim 2, wherein the predefined number is larger than 1.

4. The method of claim 2, wherein the frequency unit comprises one of: a serving cell group, a serving cell, or a bandwidth part (BWP).

5. The method of claim 1, wherein the first downlink signaling indicates, for the element, the RNTI and at least one of: a physical cell index (PCI), power control information, time advance (TA) information, synchronization signal block (SSB) information, rating mating information, or n_{ID}, wherein n_{ID} is a scrambling identifier (ID) used to generate scrambling sequence of a channel.

6. The method of claim 1, wherein a number of bits of the RNTI is extended beyond 16 bits.

7. The method of claim 1, wherein the element includes an information element that includes the RNTI and at least one of: physical cell index (PCI), synchronization signal block (SSB) information, power control information, time advance (TA) information, rating mating information, or n_{ID}, wherein n_{ID} is scrambling ID used to generate a scrambling sequence of a channel

8. The method of claim 1, further comprising at least one of:
receiving, by the wireless communication device, a channel associated with the element according to the RNTI;
transmitting, by the wireless communication device, a channel associated with the element according to the RNTI.
receiving, by the wireless communication device, a signal associated with the element according to the RNTI;
determining, by the wireless communication device, a signal for a control resource set (CORESET) associated with the element; or
transmitting, by the wireless communication device, a signal associated with the element according to the RNTI.

9. The method of claim 8, wherein the channel or the signal associated with the element includes at least one of:
a channel or a signal which is included in the element;
a channel or a signal that is scheduled by a physical downlink control channel (PDCCH) of the element; or
a channel or a signal with a parameter corresponding to the element.

10. The method of claim 9, further comprising:
receiving, by the wireless communication device, a second downlink signaling carrying the parameter of the channel or the signal; or
determining, by the wireless communication device, the RNTI of the channel or the signal according to a RNTI of the element corresponding to the parameter.

11. The method of claim 1, further comprising:
receiving, by the wireless communication device, a third downlink signaling with a parameter; or
determining, by the wireless communication device, a resource group for which the parameter is applied according to the element corresponding to the parameter;
wherein the resource group includes a channel resource group or a reference signal resource group.

12. The method of claim 11, further comprising:
receiving, by the wireless communication device, a fourth downlink signaling carrying a relationship between the resource group and the element.

13. The method of claim 1, further comprising:
determining, by the wireless communication device, the element of a channel or a signal according to a parameter of the channel or signal.

14. The method of claim 9, further comprising:
receiving, by the wireless communication device, a fifth downlink signaling indicating a relationship between the parameter and the element.

15. The method of claim 9, wherein the parameter includes one of: a Transmission Configuration Indicator (TCI) state, a spatial relation indicator, a TCI state pool, or a spatial relation indicator pool.

16. The method of claim 1, wherein the RNTI comprises at least one of: a Cell-RNTI (C-RNTI), a Modulation and Coding Scheme-C-RNTI (MCS-C-RNTI), a Configured Scheduling (CS)-RNTI (CS-RNTI), a Semi-Persistent (SP)-Channel State Information (CSI)-RNTI (SP-CSI-RNTI), or a RNTI used to identify the wireless communication device.

17. A wireless communication method, comprising:
transmitting, by a wireless communication node to a wireless communication device, a first downlink signaling,
herein the first downlink signaling is configured to indicate a Radio Network Temporary Identifier (RNTI) associated with an element.

18. A wireless communication device, comprising:
at least one processor configured to:
receive, via receiver from a wireless communication node, a first downlink signaling,
wherein the first downlink signaling is configured to indicate a Radio Network Temporary Identifier (RNTI) associated with an element.

19. A wireless communication node, comprising:
at least one processor configured to:
transmit, via a transmitter to a wireless communication device, a first downlink signaling,
herein the first downlink signaling is configured to indicate a Radio Network Temporary Identifier (RNTI) associated with an element.

20. The wireless communication node of claim 19, wherein a frequency unit includes up to a predefined number of elements, each of the predefined number of elements associated with a respective RNTI.
